(19) United States
(12) Patent Application Publication
(10) Pub. No.: US 2008/0299354 A1
(43) Pub. Date: Dec. 4, 2008

(54) THERMOPLASTIC SHEET WITH METALLIC HOT STAMP FILM, APPARATUS, AND METHOD

(76) Inventor: Rich Zydonik, Findlay, OH (US)

Correspondence Address: FRASER CLEMENS MARTIN & MILLER LLC, 28366 KENSINGTON LANE, PERRYSBURG, OH, 43551, US

(21) Appl. No.: 12/129,124

(22) Filed: May 29, 2008

Related U.S. Application Data
(60) Provisional application No. 60/941,303, filed on Jun. 1, 2007.

(51) Int. Cl. B32B 7/02; B32B 9/00; B32B 33/00; B29C 47/00; B29C 47/92

(52) U.S. Cl. 428/195.1; 428/411.1; 428/337; 428/332; 156/500; 156/64

(57) ABSTRACT

A laminate thermoplastic sheet, and an apparatus and a method of making the sheet are disclosed. The laminate sheet includes a cap layer and a substrate layer bonded together. The cap layer is adapted to provide a corrosion, scratch, and smudge resistant decorative metallic finish to the laminate sheet. The apparatus and the method of producing the sheet includes extruding the substrate layer; feeding a sheet film material for the cap layer in substantial alignment with the substrate layer; providing a machine that compresses the two layers together and facilitates the formation of a bond therebetween to form a laminate thereof; inspecting the laminate for a sufficiency of the bond between the two layers; and cutting the laminate into a plurality of individual panels.

### CROSS-REFERENCE TO RELATED APPLICATION

This application claims the benefit of U.S. Provisional Patent Application Ser. No. 60/941,303 filed on Jun. 1, 2007.

### FIELD OF THE INVENTION

The present invention relates to a laminate thermoplastic sheet, and more specifically to a laminate thermoplastic sheet having a thermoplastic substrate layer and a metallic hot stamp film cap layer.

### BACKGROUND OF THE INVENTION

Thermoplastic sheeting is widely used in the manufacture of various industrial and consumer products. The sheeting can be made to include a decorative finish such as a desired color or texture to enhance the cosmetic appearance of a final product. Additionally, the sheeting is often a laminate of two sheets, one sheet forming a substrate layer and the second sheet forming a cap layer providing the decorative finish.

A metallic finish is one decorative finish that is often desired in final products. The metallic finish is typically accomplished by applying a metallic hot stamp film cap layer to the substrate. The film is bonded to the substrate to produce the laminar thermoplastic sheet. The metallic finish, although having a very attractive appearance when new, is subject to corrosion, scratches, and readily shows smudges such as fingerprints when in use.

The manufacture of laminate thermoplastic sheeting involves a number of separate steps to bond the diverse materials into a single sheet. The steps to achieve the final laminate sheet are typically completed by two or more separate manufacturers. For example, one manufacture will produce the substrate layer while another manufacture will produce the metallic film cap layer. A third manufacture will purchase the substrate and film and employ those materials to produce a final laminate sheet. The multiple manufacturers typically involved with producing the final laminate sheet increase a cost thereof.

It would be desirable to provide a laminate sheet having a metallic surface finish that militates against corrosion, scratches, and smudges, and can be formed using a streamlined process which minimizes a manufacturing cost thereof.

### SUMMARY OF THE INVENTION

Compatible and attuned with the present invention, a laminate sheet having a metallic surface finish that militates against corrosion, scratches, and smudges, and can be formed using a streamlined process which minimizes a manufacturing cost thereof has surprisingly been discovered.

In one embodiment, a laminate thermoplastic sheet comprises a substrate layer formed from a thermoplastic; and a cap layer formed from a film and bonded to the substrate layer to provide a substantially corrosion, scratch, and smudge resistant surface to the laminate sheet.

In another embodiment, an apparatus for producing a laminate thermoplastic sheet comprises an extruder for forming a substantially planar sheet formed from a thermoplastic; a calendar roll assembly including a plurality of rollers adapted to receive the extruded sheet therebetween to facilitate obtaining a desired thickness of the extruded sheet and transferring a heat energy from the extruded sheet; an unwind station adapted to dispense a substantially planar sheet of material in substantial alignment with the extruded sheet; a hot stamp machine including a pair of rolls adapted to receive the dispensed sheet and the extruded sheet therebetween and compress the dispensed sheet and the extruded sheet to form a laminate sheet thereof; means to evaluate a strength of the bond between the dispensed sheet and the extruded sheet; and a cutting station including means to cut the laminate sheet into a plurality of panels having a desired width and length.

In another embodiment, a method for producing a laminate thermoplastic sheet comprises the steps of extruding a thermoplastic material into a sheet; feeding a film material adjacent and in substantial alignment with the substrate material; compressing the film material and the substrate material at a selected temperature to create a bond therebetween and form a laminate thereof; inspecting the laminate for a sufficiency of the bond between the substrate material and the film material; and cutting the laminate into a plurality of individual panels.

### BRIEF DESCRIPTION OF THE DRAWINGS

The above, as well as other advantages of the invention, will become readily apparent to those skilled in the art from the following detailed description of an embodiment of the invention when considered in the light of the accompanying drawings, in which:

FIG. 1 is a perspective view of a laminate thermoplastic sheet according to an embodiment of the invention;

FIG. 2 is a schematic side elevational view of an apparatus for producing the laminate thermoplastic sheet illustrated in FIG. 1;

FIG. 3 is a schematic top plan view of the apparatus shown in FIG. 2;

FIG. 4 is an enlarged perspective view of an inspection station shown in FIGS. 2 and 3; and

FIG. 5 is a side elevational view of the inspection station shown in FIG. 4.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

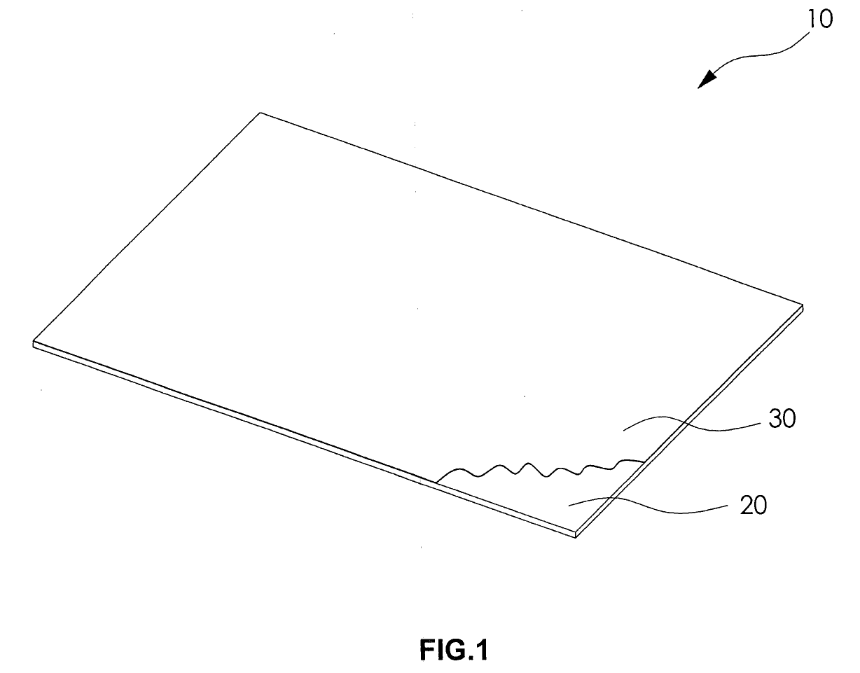

A laminate thermoplastic sheet, generally indicated by reference numeral 10, is shown in FIG. 1. The sheet 10 includes a substrate layer 20 having a first side and a spaced apart second side. The substrate layer 20 is formed by extruding a recyclable, impact modified, thermoplastic, acrylic resin as a substantially planar sheet. The resin includes a base resin. Favorable results have been obtained using such base resins from Altuglas International or Plaskolite, Inc. It should be understood that other base thermoplastic resins can be used as desired. Additives can be included with the base resin such as colorants, processing aides, and impact modifiers, for example. Favorable results have been obtained using color additives having heat stabilizers that facilitate a maintaining of color intensity under elevated temperatures. In the embodiment shown, a thickness of the substrate layer 20 is in the range of about 0.040 to 0.125 inches. It should be understood that other thickness can be used as desired.

A cap layer 30 of the sheet 10 is formed from a recyclable metallic hot stamp film. Favorable results have been obtained using a corrosion, scratch and fingerprint resistant brushed chrome film from Kurz Transfer Products having a hard coat layer on an outer surface. The hard coat layer is substantially transparent and covers the metallic layer of the film and any decorative surface finish thereon such as a brushed finish, for example. The hard coat layer causes the metallic layer to be sub-surface which militates against the corroding, scratching, and smudging of the metallic layer. It should be understood that other suitable films can be used as desired. In the embodiment shown, a thickness of the cap layer 20 is about 0.003 inches. It should be understood that other thickness can be used as desired. The cap layer 30 is bonded to a side of the substrate layer 20.

The two layer laminate thermoplastic sheet 10 can be used to form decorative panels for industrial and consumer products. Additionally, the cap layer 30 of the sheet 10 can be used as a surface for engraving. Favorable results have been found employing both laser and rotary engraving techniques to form letters, symbols, words, and the like in the cap layer 30 of the sheet 10. The engraving process typically penetrates through the cap layer 30 to expose the underlying substrate layer 20. The color of the substrate layer 20 is selected to achieve the desired color of the items engraved therein. Additionally, the metallic film provides a surface that has the appearance of real metal with the added properties of corrosion, scratch, and smudge resistance facilitating the maintenance of an unblemished appearance.

The chemical properties of the materials used in the substrate layer 20 and the cap layer 30 are compatible in respect of recycling. Regrind can be formed from scrap of the sheets 10. Regrind, as used herein, is a scrap thermoplastic composite collected in-plant or from post-consumer sources that are reground into pellets or fine powder for use in a newly extruded substrate layer 20. The regrind can be used as a filler material in the substrate layer 20 for example. Recycling the scrap from the sheet 10 back into the substrate layer 20 and other thermoplastic products substantially eliminates the need to place such scrap in a landfill, and minimizes the financial and environmental costs associated with disposing of the scrap in a landfill.

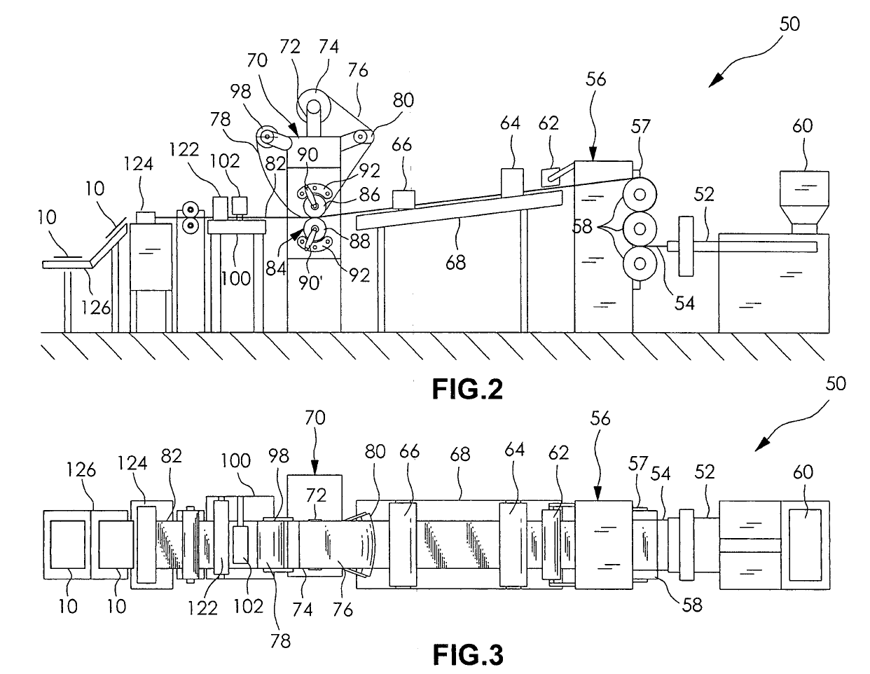

An apparatus for producing the laminate thermoplastic sheet 10 is shown in FIGS. 2-4. The apparatus 50 includes an extruder 52 adapted to receive a base resin and extrude a substantially continuous and planar sheet 54 that forms the substrate layer 30 of the sheet 10. Favorable results have been found using a screw type extruder to form the sheet 54 having a thickness of about 0.040 inches to 0.125 inches. It should be understood that other methods now known or later developed can be employed to form the sheet 54. Additionally, it should be understood that other thicknesses can be employed as desired to achieve a desired strength or other desired physical property of the sheet 54.

The resin for the sheet 54 is typically provided to the extruder through a gravity feed hopper 60 that blends the base resin with any other ingredients such as colorants, processing aides, and impact modifiers, for example, in a predetermined ratio utilizing a computerized control system. Favorable results have been obtained employing a feed hopper 60 supplied by The Conair Group, Inc. of Cranberry Township, Pa.

After emerging from the extruder 52, the sheet 54 is passed through a calendar roll 56. The calendar roll 56 includes a structural frame 57 adapted to support a plurality of rolls 58 adapted to facilitate achieving the desired thickness and the desired substantially planar characteristic of the sheet 54. Additionally, the rolls 58 are adapted to transfer a heat energy from the sheet 54. It should be understood other means can be used with the rolls 58 to transfer the heat energy from the sheet 54.

An anti-static bar 62 is provided adjacent a point where the sheet 54 emerges from the calendar roll 56. The anti-static bar 62 substantially removes a static-electrical charge that may have developed on the sheet 54. The sheet 54 is conveyed past a vacuum system 64 to substantially remove any foreign materials such as dust or dirt particles from a surface of the sheet 54. The substantial removal of any static-electrical charge and any foreign material facilitates the bonding of the cap layer 30 to the substrate layer 20 in the sheet 10. Additionally, a trim station 66 is provided adjacent the calendar roll 56 adapted to trim a selected width of material from the longitudinal edges of the sheet 54 to achieve a desired width of the sheet 54. Favorable results have been obtained employing a trim station 66 having a fixed cutting blade at each longitudinal edge of the sheet 54. It should be understood that the trim station 66 can employ a shearing means or a rotating cutting blade, for example.

A conveyor 68 is provided to support the sheet 54 from the calendar roll 56 to a laminate foil hot stamp machine 70. Additionally, the anti-static bar 62, the vacuum system 64, the trim station 66 may be attached to and supported by the conveyer 68.

The laminate foil hot stamp machine 70 is adapted to bond the substrate layer 20 and the cap layer 30 together to form the sheet 10. The machine 70 includes an unwind station 72 adapted to receive a roll 74 of a metallic film 76. The film 76 forms the cap layer 30 in the sheet 10. The unwind station 72 is adapted to dispense the film 76 in substantial alignment with the sheet 54. Further, the film 76 is typically disposed on a carrier material 78 and wound together therewith on the roll 74. A bow bar 80 is provided adjacent the roll 74. The bow bar 80 has a generally arcuate shape, wherein the film 76 is drawn across the bow bar 80 to militate against wrinkles forming in the film 76 and facilitate the aligning of the film 76 with the sheet 54 as the film 76 is unwound from the roll 74.

The unwind station 72 causes the film 76 to unwind from the roll 74 and causes a second side of the film 76 to contact a first side of the sheet 54, the two sides being in substantial alignment and forming a laminate 82 thereof including the carrier material 78 disposed on a first side of the film 76.

The sheet 54 and the film 76 are fed through a roll assembly 84 of the machine 70. The roll assembly 84 is adapted to compress the sheet 54 and the film 76 together to facilitate forming a bond therebetween. The roll assembly 84 includes an upper roll 86 and a lower roll 88 each having an eight inch diameter. The rolls 86, 88 include a silicone outer surface having a Shore A durometer in the range of about 70 to 80. It should be understood that rolls having different diameters, and rolls having different surfaces and surface hardnesses can be used. A pair of air cylinders 90, 90′ is provided to urge the respective rolls 86, 88 toward each other, minimizing a gap between outer surfaces thereof, and cooperating with the silicone surface of the rolls 86, 88 to provide a desired compressive force to the sheet 54 and the film 76 passing therethrough. Favorable results have been obtained using 100 psi air cylinders having a four inch stroke and a two and one-half inch bore diameter. It should be understood that other types of cylinders and means to urge the rolls 86, 88 toward each other can be used such as hydraulic cylinders or screw means, for example. Additionally, it should be understood that different sized cylinders, and different numbers of cylinders can be employed as desired to facilitate achieving the desired compressive force to the sheet 54 and the film 76.

The laminate foil hot stamp machine 70 includes a plurality of quartz heaters 92 to facilitate an even heating of the sheet 54 and the film 76 passing therethrough. It should be understood that other types of heaters may be used as desired. A surface temperature of the rolls 86, 88 is measured using a surface temperature probe (not shown) in slideable contact with the silicone surface of the rolls 86, 88, respectively. A non-contact temperature sensor such as an infrared temperature sensor can be employed to measure the surface temperature of the rolls 86, 88. The probes provide a representative signal of the measured temperatures to control means (not shown). The control means employs the temperature signal to selectively energize the quartz heaters 92 to maintain a desired surface temperature of the rolls 86, 88. Favorable results have been obtained employing six 4000 watt heaters in a controlled heating zone to maintain a desired temperature of the upper roll 86. Additionally, favorable results have been obtained employing three 5200 watt heaters in a controlled dual heating zone to maintain a desired temperature of the lower roll 88. It should be understood that other types, sizes, and numbers of heaters can be provided as desired.

The control means is provided to facilitate the operation of the laminate foil hot stamp machine 70. The control means is in communication with the air cylinders 90, 90′, temperature probes, and heaters 92. The control means is adapted to control the operation of the machine 70 according to a set of parameters as well as provide for manual control or emergency stoppage of the machine 70 as desired. It should be understood that the control means can also be in communication with the extruder 52 and the calendar roll 56, and effective to monitor and control the operation of the extruder 52 and the calendar roll 56.

As the laminate 82 of the sheet 54 and the film 76 emerges from between the rolls 86, 88 of the machine 70, the carrier material 78 is caused to be removed from the first side of the film 76. The carrier material 78 is received on a wind-up roll 98 removably attached to the machine 70.

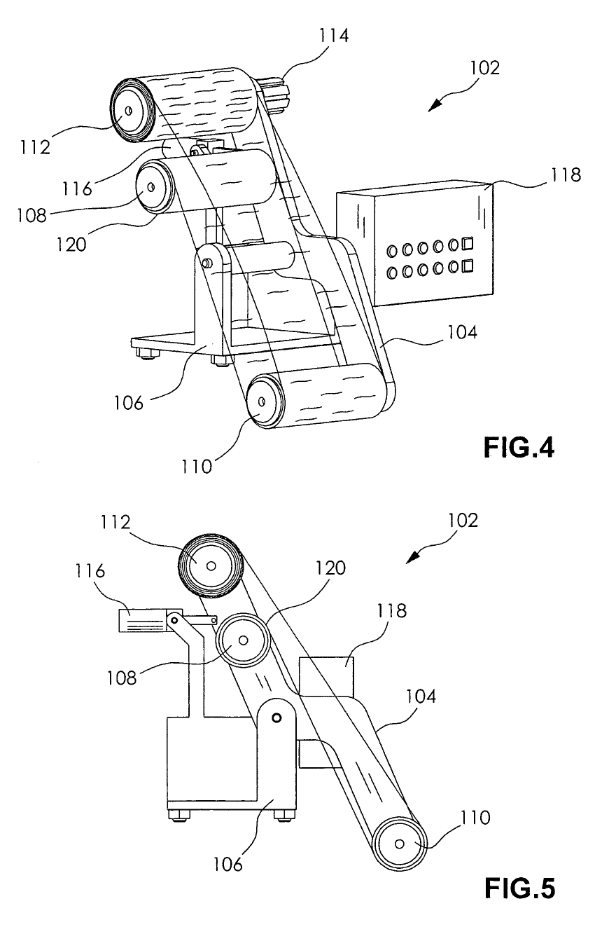

A conveyor 100 is provided to support the laminate 82 from the machine 70 through an inspection station 102. The inspection station 102 is adapted to verify that a sufficient bond is achieved between the sheet 54 and the film 76. The inspection station 102, more clearly illustrated in FIGS. 4 and 5, includes an arm 104 pivotally attached to a base 106. The base 106 is fixed to a structural member of the conveyer 100. It should be understood that the arm 104 can be pivotally attached to a structural member of the conveyer 100. The arm 104 includes a first shaft 108 for holding a roll of single sided adhesive tape 120 such as 3M® brand 600 or 610 tape, for example. The tape 120 is dispensed from the first shaft 108 around a roller 110 and received on a second shaft 112. Drive means 114 is provide to cause a rotation of the second shaft 112 which pulls the tape 120 from the first shaft 108 and around the roller 110. The tape 120 is dispensed having the adhesive side oriented as the outer surface as the tape 120 traverses past the roller 110.

The inspection station 102 includes an air cylinder 116 attached to the base 106 and the arm 104. The air cylinder 116 is adapted to cause the arm 104 to pivot in respect to the base 106. The air cylinder 116 causes the arm 104 to pivot to a point where the roller 110 is placed in a position which causes the adhesive side of the tape 120 to contact the film 76 of the laminate 82 as the laminate is conveyed through the inspection station 102. The inspection station 102 includes control means 118 in communication with the air cylinder 116 and the drive means 114. The control means 118 is effective for controlling an actuation of the air cylinder 116 and a rotational speed of the second shaft 112. If the bond between the sheet 54 and the film 76 is insufficient, the film 76 is separated from sheet 54 by the tape 120.

An edge flake removal system 122 is provided adjacent the inspection station 102 and secured to the conveyor 100. The laminate 82 can include a portion of the film 76 extending past the longitudinal edges of the sheet 54. The removal system 122 is adapted to remove any superfluous film 76 extending past the longitudinal edges of the sheet 54. It should be understood that the removal system can include a rub bar, sheering means, or a knife to remove the superfluous film material. The removal system 122 includes a vacuum system to clean from the laminate 82 any superfluous film 76 that was removed. The removal system 122 provides a clean edge to the laminate 82, a clean edge being an edge that is free from flakes of the film 76. In the embodiment shown the removal system 122 is attached to the conveyer 100.

The laminate 82 is then conveyed to means for cutting 124 to cut the laminate 82 into the final individual panels, sheet stock, or sheet 10. The means for cutting 124 is adapted to cut the laminate 82 to a selected width and length. The means for cutting 124 includes alignment means to facilitate an accurate and repeatable cutting process. The sheets 10 are received on a conveyor 126 and can then be uniformly stacked and packaged together as desired for shipping to a customer. Favorable results have been obtained employing a shearing device to cut the laminate 82 into individual sheets 10. However it should be understood that other means may be employed to cut the laminate 82 such as a rotating cutting blade or a stationary cutting blade, for example. It should be understood that a photo eye system or other dimensional monitoring system such as a camera system, for example, can be provided to facilitate an accurate and repeatable cutting process.

The apparatus and method for producing the sheet 10 minimizes a cost thereof by simplifying the manufacturing process into a single continuous process as compared to the typical multi-step manufacturing process of such plastic laminates. Further, the unique hot stamp machine 70 maximizes the bond created between the substrate 20 and cap 30 in the final sheet 10 by optimizing the temperature and compressive force employed during the formation of the bond. The maximized bond maximizes the overall quality and durability of the two layer laminate thermoplastic sheet 10.

From the foregoing description, one ordinarily skilled in the art can easily ascertain the essential characteristics of this invention, and without departing from the spirit and scope thereof, can make various changes and modifications to the invention to adapt it to various usages and conditions.

What is claimed is:

1. A laminate thermoplastic sheet comprising:
a substrate layer formed from a thermoplastic; and
a cap layer formed from a film and bonded to the substrate layer to provide a substantially corrosion, scratch, and smudge resistant surface to the laminate sheet.

2. The sheet according to claim 1, wherein the substrate layer and the cap layer are chemically compatible to facilitate a recycling of the sheet.

3. The sheet according to claim 1, wherein the thermoplastic includes a recyclable acrylic base resin.

4. The sheet according to claim 3, wherein at least one of a colorant, processing aid, and an impact modifier is included with the base resin.

5. The sheet according to claim 1, wherein the thermoplastic includes a regrind material.

6. The sheet according to claim 1, wherein a thickness of the substrate layer is between about 0.040 and 0.125 inches.

7. The sheet according to claim 1, wherein the film has a first surface in contact with a surface of the substrate and a spaced apart second surface forming a visible decorative surface of the sheet.

8. The sheet according to claim 7, including a substantially transparent hard coat layer disposed on the second surface of the film, the hard coat layer providing a substantially corrosion, scratch, and smudge resistant surface to the film.

9. The sheet according to claim 1, wherein a thickness of the cap layer is about 0.003 inches.

10. An apparatus for producing a laminate thermoplastic sheet comprising:
an extruder for forming a substantially planar sheet formed from a thermoplastic;
a calendar roll assembly including a plurality of rollers adapted to receive the extruded sheet therebetween to facilitate obtaining a desired thickness of the extruded sheet and transferring a heat energy from the extruded sheet;
an unwind station adapted to dispense a substantially planar sheet of material in substantial alignment with the extruded sheet;
a hot stamp machine including a pair of rolls adapted to receive the dispensed sheet and the extruded sheet therebetween and compress the dispensed sheet and the extruded sheet to form a laminate sheet thereof;
means to evaluate a strength of the bond between the dispensed sheet and the extruded sheet; and
a cutting station including means to cut the laminate sheet into a plurality of panels having a desired width and length.

11. The apparatus according to claim 10, including an anti-static bar to substantially remove a static charge from the extruded sheet.

12. The apparatus according to claim 10, including a vacuum system to substantially clean at least one surface of the extruded sheet.

13. The apparatus according to claim 10, including means to cut at least one longitudinal edge of the extruded sheet to provide a desired width thereof.

14. The apparatus according to claim 10, wherein the hot stamp machine includes at least one source of thermal energy to maintain a desired temperature of the rolls therein.

15. The apparatus according to claim 14, wherein the rolls of the hot stamp machine include:
a silicone outer surface having a Shore A durometer in the range of about 70 to 80, and
means to urge the rolls toward each other to reduce an axial gap therebetween, wherein the silicone outer surface and the means to urge the rolls toward each other cooperate to provide a desired compressive force to the dispensed sheet and the extruded sheet received therebetween.

16. The apparatus according to claim 15, including means to control the source of thermal energy to facilitate maintaining the desired temperature of the rolls, and means to control the means to urge the rolls toward each other to facilitate maintaining the desired compressive force applied to the dispensed sheet and the extruded sheet.

17. The apparatus according to claim 16, including at least one temperature sensor in communication with the means to control the source of thermal energy for detecting a temperature of at least one of the rolls of the hot stamp machine and sending a signal representative of the detected temperature to the means to control the source of thermal energy.

18. The apparatus according to claim 10, wherein the means to evaluate a strength of the bond between the dispensed sheet and the extruded sheet includes an adhesive member in removable contact with at least one of the dispensed sheet and the extruded sheet of the laminate sheet.

19. The apparatus according to claim 10, including means to substantially remove any portion of the dispensed material extending outwardly from a longitudinal edge of the extruded sheet.

20. A method for producing a laminate thermoplastic sheet comprising the steps of:
extruding a thermoplastic material into a sheet;
feeding a film material adjacent and in substantial alignment with the substrate material;
compressing the film material and the substrate material at a selected temperature to create a bond therebetween and form a laminate thereof;
inspecting the laminate for a sufficiency of the bond between the substrate material and the film material; and
cutting the laminate into a plurality of individual panels.
